(19) United States
(12) Patent Application Publication
(10) Pub. No.: US 2009/0256691 A1
(43) Pub. Date: Oct. 15, 2009

(54) METHOD AND APPARATUS FOR IMPLEMENTING DISTINCTIVE ALERTS

(76) Inventor: Lisa Marie Hjulberg, Riverside, CA (US)

Correspondence Address: MERCHANT & GOULD PC, P.O. BOX 2903, MINNEAPOLIS, MN, 55402-0903, US

(21) Appl. No.: 12/102,424

(22) Filed: Apr. 14, 2008

(51) Int. Cl. B60R 25/00; G08B 3/00

(52) U.S. Cl. 340/426.1; 340/384.4

(57) ABSTRACT

A method and apparatus for implementing distinctive alerts in a security alarm system for a vehicle. A plurality of distinctive alarm sounds are provided from which the user can select one that he or she prefers. The number of alarm sounds is large enough so that it is unlikely that vehicles that are in close physical proximity to each other will employ the same alarm sound. Thus, with respect to any one user, the selected alarm sound will be distinctive to that user. Accordingly, when an automobile alarm sound is heard, the user can associate the alarm with his or her vehicle. The user may also receive a text message or call to his or her cell phone or land line phone.

### BACKGROUND OF THE INVENTION

The present invention is generally directed to the field of security and, more particularly, is directed to a method and apparatus for implementing distinctive alerts in various environments where such alerts are needed. Such environments include security systems, smoke and fire detectors and the like.

The invention has particular application in automobile alarm systems, as well as other places where a number of people might hear the same alarm sound and need to know whether the alarm is designed for their attention. In other situations, the alarm sound is intended to get the attention of everyone who hears it. For example, public fire, smoke and burglar alarms fall into this category. On the other hand, home alarms are designed to attract the attention of the home owner.

With respect to automobiles, when a security alarm is triggered it emits a loud sound that is intended to attract not only attention, but to also scare off an intruder. Thus, alarm systems should be designed to serve a plurality of purposes.

When electronic alarms, such as car and smoke alarms, first became popular, they were likely very effective for their intended purpose. However, due to the prevalence of such systems today and the many false alarms they generate, many people have become immune to responding when the alarm is heard and assume that it is a false alarm.

The above described problems with alarm systems that are known in the prior art is compounded by the fact that most alarms sound the same. Thus, when the alarm sounds, a person can not determine with any degree of precision that the alarm is coming from their, e.g., automobile, and/or that the alarm is intended to get their specific attention. Thus, there is a tendency to dismiss the alarm as not coming from their vehicle or assume that the alarm does not call for action on their part.

What is needed in the art is a way for the user of an automobile security system, as well as other alarm systems, to know with accuracy whether an alarm is coming from their vehicle or someone else's vehicle. The present invention achieves this purpose.

### SUMMARY OF THE INVENTION

The present invention is directed to a method and apparatus for implementing distinctive alerts in an alarm system. The invention has particular application in an automotive security alarm system, but may be used in any system that is designed to provide an alert when triggered by a predetermined condition. Such other systems would include fire, smoke and burglar alarms.

The present invention is described in connection with an automobile alarm, but as pointed out above, the invention is not limited thereto.

In accordance with the present invention, a plurality of distinctive alarm sounds is provided from which the user can select one that he or she prefers. The number of alarm sounds is large enough so that it is unlikely that two vehicles that are in close physical proximity to each other will employ the same alarm sound. Thus, with respect to any one user, the selected alarm sound will be distinctive to that user. Accordingly, when an automobile alarm sound is heard, the user will know instantly whether the sound is likely emanating from his or her vehicle.

The novel features of the present invention are set out with particularity in the following detailed description of the preferred embodiment. However, the invention will be understood more fully and clearly from the detailed description of the invention as set forth in the accompanying drawings in which:

### BRIEF DESCRIPTION OF THE DRAWINGS

FIG. 1 is a block diagram showing the overall structure of the present invention; and

FIG. 2 is a further block diagram of the present invention illustrating its use in an after market environment.

### DETAILED DESCRIPTION OF THE PREFERRED EMBODIMENT

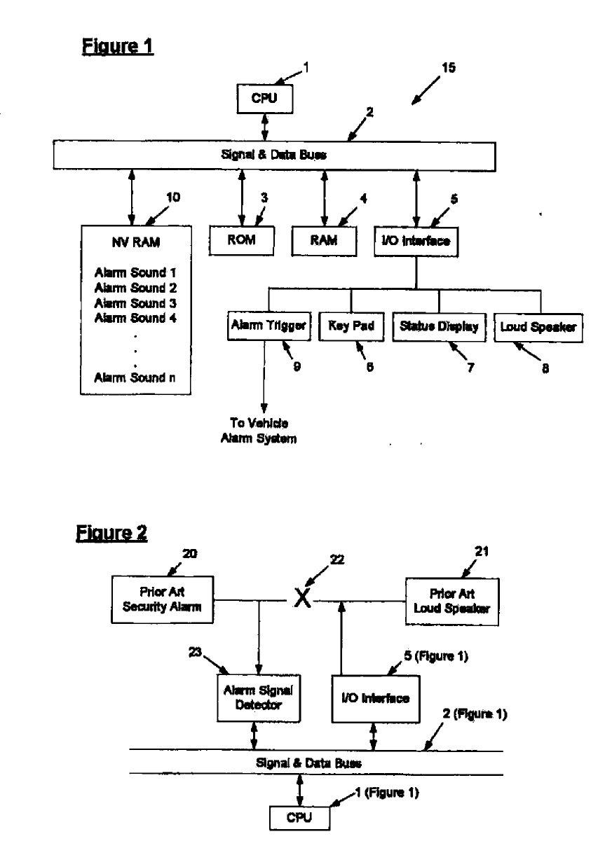

FIG. 1 is a block diagram illustrating the overall construction of an electronic control module 15 that can be used to implement a preferred embodiment of the present invention.

As shown in FIG. 1, module 15 includes a CPU 1 (central processing unit) for executing computer software instructions as is known in the art. CPU 1 is coupled to a number of other elements via a signal and data buss 2 as also known in the art. These elements include ROM 3 (read only memory) which may be used to store the aforementioned software computer instructions, RAM 4 (random access memory) which may be used to store intermediate variables and calculations, I/O Interface 5 which may be used to allow CPU 1 to interface with elements that are external to module 15, and Non Volatile RAM 10 which may be used to store configuration variables for module 15, as well as a plurality of alarm sounds.

As mention above, I/O Interface 5 is used to interface CPU 1 to elements that are external to module 15. These external elements include Key Pad 6, Status Display 7, Loud Speaker 8 and Alarm Trigger 9.

Key Pad 6 can be formed in a number of ways so that users of the system have a way to input commands and user selections, such as selecting a desired alarm sound from the plurality of alarm sounds that are stored in NV RAM 10.

Status Display 7 may be formed of an LCD (liquid crystal display) screen as is known in the art. The status display provides visual feedback to the user with respect to, for example, system prompts from CPU 1, a scrollable display of the available alarm sounds that are stored in NV RAM 10, as well as various other system information that one of ordinary skill in the art would expect in accordance with the present invention.

Load Speaker 8 is a speaker of sufficient size to sound an alert at an appropriate volume and for an appropriate duration as is known in the art.

Alarm Trigger 9 inputs an alarm trigger from the alarm system indicating that the alarm system has detected a condition wherein an alert alarm should be sounded.

As described above, the distinctive alarm system of the present invention may be integrated into vehicle alarm systems that are known in the prior art during the manufacturing process.

The system of the present invention may also be added to vehicle alarm systems that have already been installed in vehicles, i.e., after market. FIG. 2 illustrates one example of an embodiment with respect to this approach.

FIG. 2 shows a prior art vehicle security alarm 20 with its associated prior art Loud Speaker 21. In accordance with this embodiment of the present invention, Loud Speaker 21 would be disconnected from Security Alarm System 20 at a convenient point 22. An Alarm Signal Detector 23 in accordance with the present invention is provided and is coupled to Security Alarm System 20 as shown in FIG. 2. The purpose of Detector 23 is to detect the present of an alarm signal that otherwise would be sent to Loud Speaker 21. When such a signal is detected, CUP 1 shown in FIG. 1 is alerted via I/O Interface 5. CPU 1 then causes the user selected alarm sound stored in NV RAM 20 to be output to Loud Speaker 21 via I/O Interface 5 as shown in FIG. 2.

Module 15 of the present invention may also be configured to interface with a cell phone or land line via I/O Interface 5 so that when the security alarm is sounded, a text message, phone call or other signal is automatically sent to the vehicle owner as one of ordinary skill in the art would understand how to do.

It should be obvious from the above-discussed embodiment of the present invention that numerous other variations and modifications of the invention are possible, and such will readily occur to those skilled in the art. Accordingly, the scope of this invention is not to be limited to the embodiment disclosed, but is to include any such embodiments as may be encompassed within the scope of the above described preferred embodiment.

I claim:

1. A security alarm system, said alarm system comprising:
a control unit;
an intrusion detection device coupled to said control unit;
at least one memory store coupled to said control unit, wherein said memory store stores a plurality of electronic alarm sounds; and
an audio output device coupled to said control unit for sounding one of said electric alarm sounds when an intrusion is detected by said intrusion detection device.

2. The security alarm system of claim 1, further including an alarm selection device for selecting one of said electronic alarm sounds for sounding by said audio output device.

3. The security alarm system of claim 2, wherein said alarm selection device allows a user to select one of said electronic alarm sounds that is distinct from others of said electronic alarm sounds.

4. The security alarm system of claim 1, wherein said intrusion detection device provides an intrusion detection signal when an intrusion is detected within a predetermined zone to be protected.

5. The security alarm system of claim 4, wherein said predetermined zone is an automobile.

6. The security alarm system of claim 4, wherein said predetermined zone is a truck.

7. The security alarm system of claim 4, wherein said predetermined zone is a vehicle.

8. The security alarm system of claim 4, wherein said predetermined zone is a room.

9. The security alarm system of claim 1, wherein each of said electronic alarm sounds is distinct from each other.

10. The security alarm system of claim 1, further including an electronic alarm sound input device coupled to said control unit, said electronic alarm sound input device being adaptable for inputting additional said electronic alarm sounds into said memory store.
